(19) United States
(12) Patent Application Publication
(10) Pub. No.: US 2017/0164026 A1
(43) Pub. Date: Jun. 8, 2017

(54) METHOD AND DEVICE FOR DETECTING VIDEO DATA

(71) Applicants: LE HOLDINGS (BEIJING) CO., LTD., Beijing (CN); LE SHI ZHI XIN ELECTRONIC TECHNOLOGY (TIANJIN) LIMITED, Tianjin (CN)

(72) Inventor: Yunlong LI, Tianjin (CN)

(21) Appl. No.: 15/248,546

(22) Filed: Aug. 26, 2016

Related U.S. Application Data
(63) Continuation of application No. PCT/CN2016/008935, filed on Jul. 8, 2016.

(30) Foreign Application Priority Data
Dec. 4, 2015 (CN) 201510889781.9

(51) Int. Cl. H04N 21/24; H04N 17/00; H04N 21/845; G06K 9/00; H04N 21/235; H04N 21/8358; H04N 21/234

(52) U.S. Cl. CPC H04N 21/2407; H04N 21/8358; H04N 17/004; H04N 21/23418; G06K 9/00744; G06K 9/00765; H04N 21/235; H04N 21/8456; G06K 2209/25

(57) ABSTRACT

Embodiments of the present disclosure disclose a method and a device for detecting video data. The method comprises: receiving frame data of image frames of a video played previously, the frame data including watermark time sequence information; extracting the watermark time sequence information from each piece of frame data to determine presentation time of the image frame corresponding to each piece of frame data; detecting continuity of the image frames based on the presentation time of the image frames and generating a detection result of the video. According to the embodiments of the present disclosure, the accuracy of detection is improved; meanwhile, the problem of slow detection progress due to manual detection on playing hysteresis of a video is avoided, and the detection efficiency is improved while the workload of the testing technician is reduced.

### CROSS-REFERENCE TO RELATED APPLICATIONS

This application is a continuation of International Application No. PCT/CN2016/089357 filed on Jul. 8, 2016, which is based upon and claims priority to Chinese Patent Application No. 201510889781.9, entitled “METHOD AND DEVICE FOR DETECTING VIDEO DATA”, filed on Dec. 4, 2015, the entire contents of which are incorporated herein by reference.

### TECHNICAL FIELD

The present disclosure generally relates to the technical field of videos, and in particular, to a method for detecting video data and a device for detecting video data.

### BACKGROUND

When a video is played, hysteresis of playing or loss of data (e.g., video frame loss) may occur easily, leading to non-fluent playing of the video. In order to guarantee fluent playing of videos and enhance the experience of users, detection is required on the conditions of hysteresis of playing and loss of data of the videos.

The inventor has found out in the process of implementing the present disclosure that the playing conditions of videos are mainly detected by the technician to determine the conditions of hysteresis of playing and loss of data of the videos at present. Taking playing of online videos as an example, in the playing process, the test engineer watches the videos to determine the conditions of hysteresis of playing and loss of data of the videos; alternatively, according to problems fed back by users, the problems of hysteresis of playing and loss of data of online videos are discovered. However, it is hard to record time points corresponding to hysteresis in the playing process of a video by means of manual detection; besides, the detection progress is limited.

Apparently, accurate statistics cannot be realized on the probability of occurrence of hysteresis and time points of hysteresis by means of manual detection on the playing hysteresis of videos at present, and the detection efficiency is low.

### SUMMARY

The technical problem to be solved by an embodiment of the present disclosure is to disclose a method for detecting video data, in order to solve the problem of limited video detection progress due to manual detection and improve the accuracy of detection while improving the efficiency of detection.

Accordingly, another embodiment of the present disclosure further provides a device for detecting video data to ensure the implementation and application of the above method.

According to an embodiment of the present disclosure, there is provided a method for detecting video data, including:

at an electronic device,

receiving frame data of image frames of a video played previously, the frame data including watermark time sequence information;

extracting the watermark time sequence information from each piece of frame data and determining presentation time of the image frame corresponding to each piece of frame data;

detecting continuity of the image frames based on the presentation time of the image frames and generating a detection result of the video.

According to an embodiment of the present disclosure, there is provided an electronic device for detecting video data, including:

at least one processor; and a memory communicably connected with the at least one processor for storing instructions executable by the at least one processor, wherein execution of the instructions by the at least one processor causes the at least one processor to:

receive frame data of image frames of a video played previously, the frame data including watermark time sequence information;

extract the watermark time sequence information from each piece of frame data and determine presentation time of the image frame corresponding to each piece of frame data;

detect continuity of the image frames based on the presentation time of the image frames and generate a detection result of the video.

According to an embodiment of the present disclosure, there is provided a computer program, comprising computer-readable codes, when the computer-readable codes are run on a server, the server is led to execute the method for detecting video data above.

According to an embodiment of the present disclosure, there is provided a non-transitory computer-readable medium storing executable instructions that, when executed by an electronic device, cause the electronic device to: receive frame data of image frames of a video played previously, the frame data including watermark time sequence information; extract the watermark time sequence information from each piece of frame data and determine presentation time of the image frame corresponding to each piece of frame data; and detect continuity of the image frames based on the presentation time of the image frames and generate a detection result of the video.

Compared with the prior art, the embodiments of the present disclosure have the following advantages:

according to the embodiments of the present disclosure, after the frame data of image frames of a video played previously is received, watermark time sequence information included in the frame data is extracted to determine presentation time of the image frame corresponding to each piece of frame data, and the continuity of the image frames is detected on the basis of the presentation time of the image frames and then a detection result of the video is generated; therefore, accurate statistics can be realized on the probability of occurrence of hysteresis and time points of hysteresis, and the accuracy of detection is improved. Meanwhile, the problem of slow detection process due to manual detection on playing hysteresis of a video is avoided, and the detection efficiency is improved while the workload of the testing technician is reduced.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a step flow diagram of a method for detecting video data in accordance with some embodiments.

FIG. 2 is a step flow diagram of a method for detecting video data in accordance with some embodiments.

FIG. 3A is a structural block diagram of a device for detecting video data in accordance with some embodiments.

FIG. 3B is a structural block diagram of a preferred embodiment of a device for detecting video data in accordance with some embodiments.

FIG. 4 exemplarily shows a block diagram of an electronic device for executing a method according to the present disclosure.

FIG. 5 exemplarily shows a storage unit for holding or carrying program codes for executing a method according to the present disclosure.

### DETAILED DESCRIPTION

In order to make the objectives, technical solutions and advantages of the embodiments of the present disclosure more clear, the technical solutions in the embodiments of the present disclosure will be described below clearly and completely in conjunction with the accompanying drawings in the embodiments of the present disclosure. Apparently, the described embodiments are part of embodiments of the present disclosure, but not all embodiments. On the basis of the embodiments in the present disclosure, all the other embodiments obtained by a person skilled in the art without creative work should fall into the scope of protection of the present disclosure.

At present, the manual discovery method of detecting video playing hysteresis and video data loss has the following problems: 1, the human resources of testing engineers are wasted; 2, automatic detection cannot be realized; that is, idle time (e.g., in the night) cannot be effectively utilized, leading to limited detection progress and low detection efficiency; 3, accurate statistics cannot be realized on the probability of occurrence of hysteresis and time points of hysteresis, i.e., low accuracy of detection.

Aiming at the above problems, one core concept of the embodiments of the present disclosure is to extract watermark time sequence information from frame data of image frames of a video, determine the presentation time of each image frame corresponding to each piece of frame data according to the watermark time sequence information, detect the continuity of the image frames of the video and generate the detection result of the video; therefore, accurate statistics can be realized on the probability of occurrence of hysteresis and time points of hysteresis, and the accuracy and the efficiency of detection are improved.

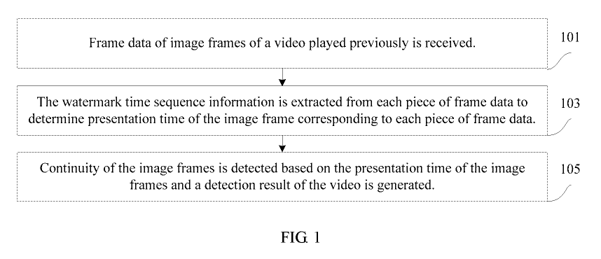

By referring to FIG. 1, which shows the step flow diagram of one embodiment of the method for detecting video data of the present disclosure, the method may specifically include the steps as follows.

Step 101, frame data of image frames of a video played previously is received.

The frame data therein includes watermark time sequence information. Actually, in the process of coding, the watermark time sequence information can be added to each image frame of a video. Specifically, in the video coding process, watermarks may be added to the image frames of the video by means of the watermark technology; the content of each watermark includes the presentation time sequence information of each image frame of the video, for example, a frame number of the image frame and a time stamp; therefore, the frame data of each image frame includes the watermark time sequence information.

Optionally, the watermark may be added to a specified region of each image frame, i.e., embedded in relatively invariant regions of a video. For example, on the basis of basically invariant position of a video logo in each image frame, vulnerably transparent watermark time sequence information may be added to the logo of a video. Specifically, the frame number or the time stamp of each image frame of a video source is converted into a 32-bit binary number by quantization, for instance, a quantized presentation time stamp (PTS). During coding, the quantized PTS (equivalent to the time sequence information) is embedded into P macroblocks of the logo as the vulnerably transparent watermark. As the watermark is vulnerably transparent, human eyes cannot see the watermark in display; therefore, the display of the image frames is not affected, and the display integrity of the image frames of the video is guaranteed.

In practicable use, when a smart terminal, for example, a smart phone, play a video, the frame data of decoded image frames may be extracted and forwarded to a hysteresis frame loss analyzing server (hereinafter referred to as server). Specifically, the smart terminal may obtain the frame data to be displayed on a display screen by calling a screenshot interface, for example, an interface provided by Surface Flinger service of Android system; alternatively, interception of data in a specified region (e.g., a logo region) of the display screen may be directly driven by an LCD (Liquid Crystal Display), thereby obtaining the frame data of the image frames. For example, the frame data may be data generated according to a YUV format, i.e., YUV data, wherein Y represents luminance, while U and V represent chrominance. After the server receive the frame data of the image frames of the played video, an automatic detection may be performed on the frame data of the image frames of the video to generate a detection result of the video. The specific detection process will be described below.

It needs to be noted that frame data between the smart data and the server may be transmitted via a network, for example, TCP_SOCKET, or via a USB (Universal Serial Bus) serial port, for example, ADB (Android Debug Bridge), which is not limited in this embodiment of the present disclosure.

Optionally, the above step 101 may include the substeps as follows.

Substep 10101, a connection with a smart terminal where a player resides is established in a wireless or wired way.

Substep 10103, the frame data extracted by the smart terminal from specified regions of the image frames is received.

The image frames in the above step are image frames played in the video played previously by the player.

Step 103, the watermark time sequence information is extracted from each piece of frame data to determine presentation time of the image frame corresponding to each piece of frame data.

After the frame data is received, the server may extract the watermark time sequence information from each piece of frame data through inverse conversion, and parse the watermark time sequence information to determine the presentation time of the image frame corresponding to each piece of frame data. As described in the above example, the watermark time sequence information is added to the logo regions; after the frame data is received, the server may determine the parity of the macroblocks of the logo regions by traversing the macroblocks to restore the time sequence information embedded in the watermarks during coding, i.e., determine the presentation time of the image frames. For instance, the server may traverse the parity of 32 macroblocks, and map odd numbers into 1 and even numbers into 0, thereby obtaining a 32-bit binary number and restoring the PTS embedded into the watermark during coding, i.e., determining the presentation time of each image frame. Further for instance, the presentation time of each image frame is represented by a hexadecimal number; assuming that the presentation time of the first image frame of a video is 16 ms, the presentation time of the first image frame of the video can be determined as 0x00000010 ms through calculation.

Of course, in order to keep robustness, the server may also traverse two macroblocks to determine a single-bit binary coefficient (X, Y), i.e., traverse the parity of 64 macroblocks to determine implementation time of one image frame, wherein X and Y may be 1 or 0. When X and Y are the same, for example, both being 1 or 0, the parity of each macroblock can be determined according to the value of X or Y. This embodiment of the present disclosure does not limit the implementation way of restoring the watermark time sequence information into the presentation time of each image frame.

Optionally, the above step 103 may also include the substeps as follows.

Substep 10301, with respect to each piece of frame data, the watermark time sequence information is extracted from the frame data.

Substep 10303, the extracted watermark time sequence information is parsed to determine the presentation time of the image frame corresponding to the frame data.

Step 105, continuity of the image frames is detected based on the presentation time of the image frames and a detection result of the video is generated.

Actually, during normal and fluent playing of a video, the extracted presentation time of the image frames is supposed to uniformly and progressively increase. The presentation time of the image frames is compared with synchronization time to determine whether the presentation time of the image frames changes regularly, and therefore, hysteresis conditions during playing of the video can be determined. Specifically, the presentation time of each image frame is compared with the local NTP (Network Time Protocol) time of the server, so that a timegap corresponding to each image frame can be obtained. When the timegap corresponding to one image frame is not within a preset playing time range, it can be regarded that hysteresis occurs at playing of the image frame; the presentation time of the image frame is then regarded as a hysteresis time point and recorded.

Optionally, the step of detecting the continuity of the image frames based on the presentation time of the image frames and generating the detection result of the video may include: calculating a difference value between the presentation time of each image frame and synchronization time information generated in advance to generate a timegap corresponding to each image frame; determining whether the timegaps corresponding to the image frames are within a playing time range, respectively; when the timegap corresponding to one image frame is not within the playing time range, regarding the presentation time point of the image frame as a hysteresis time point, and generating a hysteresis detection result of the video.

In addition, whether frame loss occurs in the video can be determined by determining whether the presentation time of the image frames increases uniformly and progressively. Specifically, when a presentation time interval between two adjacent image frames is greater than an interframe timegap corresponding to the video, it can be determined that an image frame is missing between the two image frames, i.e., loss of data between the two image frames. The time point of frame loss of the video can be determined by recording the presentation time of the two image frames.

In a preferred embodiment of the present disclosure, the step of detecting the continuity of the image frames based on the presentation time of the image frames and generating the detection result of the video may also include: performing a statistical operation on the presentation time of the image frames to determine an interframe timegap corresponding to the video and a presentation timegap corresponding to every two adjacent image frames; determining whether the presentation timegap corresponding to the two image frames is greater than the interframe timegap; when the presentation timegap is greater than the interframe timegap, determining loss of data between the two image frames and generating a frame loss detection result of the video.

On the basis of the frame loss condition and/or hysteresis condition of a video, the frame loss hysteresis analyzing server may automatically generate the detection result(s) of the video, such as the hysteresis detection result, the frame loss detection result, and the like. The detection results may include a video frame loss time point, a hysteresis time point and the like; therefore, accurate statistics can be realized on the probability of occurrence of hysteresis and time points of hysteresis, and the accuracy of detection is improved.

In this embodiment of the present disclosure, the server may automatically detect the conditions of video playing hysteresis and video data loss by extracting the watermark time sequence information in the frame data of the image frames, and generates video detection results; therefore, the workload of test engineers is reduced, and the human resources are saved; as a result, the cost of detection is reduced. Besides, the server may perform automatic detection, i.e., detection on videos in idle time; therefore, the detection progress is accelerated and the efficiency of detection is improved.

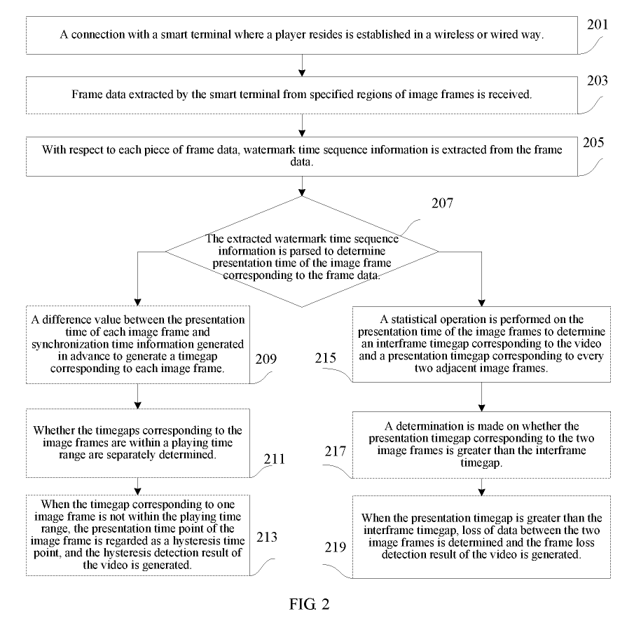

By referring to FIG. 2, which shows the step flow diagram of one embodiment of the method for detecting video data of the present disclosure, the method may specifically include the steps as follows.

Step 201, a connection with a smart terminal where a player resides is established in a wireless or wired way.

Actually, in Internet, like a local area network, a server may be connected with the smart terminal where the players resides in the wireless or wired way, wherein the wireless way refers to wireless communication, i.e., a communication way for information exchange based on the characteristic of electric wave signals can be propagated in free space. The wired way refers to wired communication, i.e., a way of transmitting information using tangible mediums such as a metal conductor, an optical fiber and the like.

Specifically, videos generally are played by means of players of terminals, for example, the player of a smart phone or the web player of a smart terminal. When a player plays a video, the smart terminal where the smart terminal resides may connect to the server in a wireless connection way like a WI-FI connection way. Of course, the smart terminal may also be connected to the server in the wired way, for example, a universal serial bus. The connection way of the server and the smart terminal is not limited in this embodiment of the present disclosure.

Step 203, frame data extracted by the smart terminal from specified regions of image frames is received.

The image frames in the above step are image frames played in a video played previously by the player. Specifically, the player may continuously display the image frames of the video to realize playing of the video. Display of each image frame is equivalent to display of an image.

The smart terminal may obtain YUV data to be displayed on a display screen by means of Surface Flinger service provided by its own system; alternatively, interception of data in a specified region of the display screen may be directly driven by an LCD. When the player plays a video, the smart terminal may extract the frame data from the specified regions of the image frames of the video, like obtaining the YUV data from the presentation regions of a logo. The frame data of each image frame includes the presentation time information of the image frame, i.e., watermark time sequence information. The smart terminal extracts the frame data from the specified regions of the image frames, and then sends the extracted frame data to the server. The server may receive the frame data sent by the smart terminal via a network interface, such as TCP_SOCKET interface, USB serial port or the like.

Step 205, with respect to each piece of frame data, watermark time sequence information is extracted from the frame data.

After the frame data is received, with respect to each piece of frame data, the server may extract the watermark time sequence information of the image frame corresponding to the frame data from the frame data through inverse conversion; for example, the watermark time sequence information in the YUV data of the specified regions is extracted.

Step 207, the extracted watermark time sequence information is parsed to determine presentation time of the image frame corresponding to the frame data.

Specifically, the watermark time sequence information is embedded in the macroblocks of the specified regions as watermarks. The presentation time of the image frames can be determined by inversely converting the macroblocks of the watermark time sequence information, i.e., traversing the macroblocks of the specified regions to determine the parity of the macroblocks.

The continuity of the image frames may be detected afterwards on the basis of the presentation time of the image frames, and then detection results of the video may be generated. In this embodiment, the detection results of the video include a hysteresis detection result and a frame loss detection result, as specified below.

The operation of generating the hysteresis detection result of the video therein may specifically include step 209, step 211 and step 213; the operation of generating the frame loss detection result of the video may specifically include step 215, step 217 and step 219.

I. Detailed Description of the Steps of Generating the Hysteresis Detection Result of the Video

Step 209, a difference value between the presentation time of each image frame and synchronization time information generated in advance to generate a timegap corresponding to each image frame.

On the basis of the local NTP time, like System.currentTime, of the server, the actual presentation time of each image frame during playing can be determined. During video playing, synchronization time information corresponding to each image frame can be generated from the timegap of the actual playing time of each image frame relative to the starting playing time of the video.

As a specific example of this embodiment of the present disclosure, under assumptions of System.currentTime of 3500 ms, and the starting playing time of the video of 3500 ms, if the presentation time of the first image frame is 16 ms and the actual playing time thereof is 3517 ms, the synchronization time information corresponding to the first image frame is 17 ms; if the presentation time of the second image frame is 48 ms and the actual playing time thereof is 3555 ms, the synchronization time information corresponding to the second image frame is 55 ms; if the presentation time of the third image frame is 80 ms and the actual playing time thereof is 3689 ms, the synchronization time information corresponding to the third image frame is 189 ms.

The timegaps corresponding to the image frames can be generated by calculating the difference value between the presentation time of each image frame and the corresponding synchronization time information corresponding. For example, with respect to the first image frame, the difference value between the presentation time 16 ms of the image frame and the corresponding synchronization time information 17 ms is calculated, and then the timegap corresponding to the first image frame can be generated as 1 ms. Similarly, the timegap corresponding to the second image frame can be generated as 7 ms, and the timegap corresponding to the third image frame can be generated as 109 ms.

Step 211, whether the timegaps corresponding to the image frames are within a playing time range are respectively determined.

With respect to different definitions, it is acceptable that playing of online videos delays in a favorable network transmission environment. Specifically, if image frames of a video can be played within a preset playing time range, it is regarded that the image frames can be played fluently. Assuming that the playing delay of image frames of a video is within 40 ms, it can be regarded that the image frames can be played fluently, i.e., no hysteresis occurring in playing of the image frames. When the playing delay of image frames of a video exceeds 40 ms, it is regarded that hysteresis occurs in playing of the image frames. The server may determine whether the timegaps corresponding to the image frames of a video are within a playing time range (A, B), wherein A may be 0 ms, while B may be 40 ms. If the timegaps corresponding to the image frames are greater than A and less than B, it can be regarded that the video is fluent in playing; or otherwise, it is can be regarded that frame hysteresis occurs in the video. As described in the above example, the timegap corresponding to the first image frame is 1 ms, which is located within the playing time range (0 ms, 40 ms), it can be regarded that the playing of the first image frame of the video is fluent; the timegap corresponding to the third image frame is 109 ms, which is beyond the playing time range (0 ms, 40 ms), it can be regarded that hysteresis occurs at the playing of the third image frame of the video, and then step 213 is carried out.

Step 213, when the timegap corresponding to one image frame is not within the playing time range, the presentation time point of the image frame is regarded as a hysteresis time point, and the hysteresis detection result of the video is generated.

When the timegap corresponding to one certain image frame is not within the playing time range, the presentation time point of the image frame is regarded as the hysteresis time point, and the hysteresis detection result of the video is detected. As described in the above example, the timegap corresponding to the third image frame is 109 ms, which is beyond the playing time range (0 ms, 40 ms), the presentation time 80 ms of the third image frame is regarded as the hysteresis time point to generate the hysteresis detection result of the video.

All the hysteresis time points of the video can be recorded by determining whether the timegaps corresponding to all the image frames of the video are within the playing time range, and then the hysteresis detection result of the video is generated; therefore, accurate statistic can be realized on the probability of occurrence of hysteresis and the time points of hysteresis, and the accuracy of detection is improved.

II. Detailed Description of the Steps of Generating the Frame Loss Detection Result of the Video

Step 215, a statistical operation is performed on the presentation time of the image frames to determine an interframe timegap corresponding to the video and a presentation timegap corresponding to every two adjacent image frames.

As a specific example of this embodiment of the present disclosure, it is assumed that the presentation time of the image frames of one video is as shown in Table 1, wherein “first frame” represents the first image frame; “0x” represents a hexadecimal number; for example, 0x00000010 represents 16.

TABLE 1

| Frame Number of Image | |
|---|---|
| Frame | Presentation Time |
| First frame | 0x00000010 ms |
| Second frame | 0x00000030 ms |
| Third frame | 0x00000050 ms |
| Fourth frame | 0x00000090 ms |
| Fifth frame | 0x000000b0 ms |
| Sixth frame | 0x000000f0 ms |
| . . . | . . . |

According to the presentation time statistics of all the image frames of the video, the interframe timegap of the video can be determined as 32 ms, and the presentation timegap corresponding to every two adjacent image frames also can be determined. For example, the presentation timegap corresponding to the first image frame and the second image frame is 32 ms, i.e., the difference value of the presentation time 0x00000030 ms of the second image frame minus the presentation time 0x00000010 ms of the first image frame. The presentation timegaps corresponding to other two adjacent image frames may be calculated similarly. For example, the presentation timegap corresponding to the second image frame and the third image frame is 32 ms; the presentation timegap corresponding to the third image frame and the fourth image frame is 64 ms; the presentation timegap corresponding to the fourth image frame and the fifth image frame is 32 ms; the presentation timegap corresponding to the fifth image frame and the sixth image frame is 64 ms.

Step 217, a determination is made on whether the presentation timegap corresponding to the two image frames is greater than the interframe timegap.

With regard to every two adjacent image frames, the determination is made on whether the presentation timegap corresponding to the two image frames is greater than the timegap corresponding to the video. If the presentation timegap corresponding to two adjacent image frames is not greater than the interframe timegap corresponding to the video, it is regarded that no data is lost between the two image frames, i.e., no missing frame. If the presentation timegap corresponding to two adjacent image frames is greater than the interframe timegap corresponding to the video, it is regarded that data is lost between the two image frames, i.e., frame loss. For example, the presentation timegap 64 ms corresponding to the third image frame and the fourth image frame is greater than the interframe timegap 32 ms corresponding to the video, and then step 219 is carried out.

Step 219, when the presentation timegap is greater than the interframe timegap, loss of data between the two image frames is determined and the frame loss detection result of the video is generated.

When the presentation timegap corresponding to two adjacent image frames is greater than the interframe timegap corresponding to the video, loss of data between the two image frames can be determined. For example, frame loss occurs between the third image frame and the fourth image frame, and the frame loss detection result of the video is generated. The frame loss detection result of the video may record between which image frames frame loss occurs, for example, recording frame loss occurs between the third image frame and the fourth image frame and between the fifth image frame and the sixth image frame. Alternatively, it may also record between which presentation time points frame loss occurs; for example, frame loss occurs between presentation time points 0x00000050 ms and 0x00000090 ms, and between presentation time points 0x000000b0 ms and 0x000000f0 ms. The recorded content is not limited in this embodiment of the present disclosure.

In this embodiment of the present disclosure, it can be determined whether frame loss occurs between two adjacent image frames by determining whether the presentation timegap of the two adjacent image frames is greater than the interframe timegap corresponding to the video; then, the frame loss condition of the video is recorded and the frame loss detection result of the video is generated. Therefore, accurate statistic can be realized on the probability of occurrence of frame loss of the video and the time points of frame loss, and the accuracy of detection is improved.

It needs to be noted that in regard to the method embodiments, for the sake of simple descriptions, they are all expressed as combinations of a series of actions. However, a person skilled in the art should know that the embodiments of the present disclosure are not limited by the described order of actions, because some steps may be carried out in other orders or simultaneously according to the embodiments of the present disclosure. For another, a person skilled in the art should also know that the embodiments described in the description all are preferred embodiments, and the actions involved therein are not necessary for the embodiments of the present disclosure.

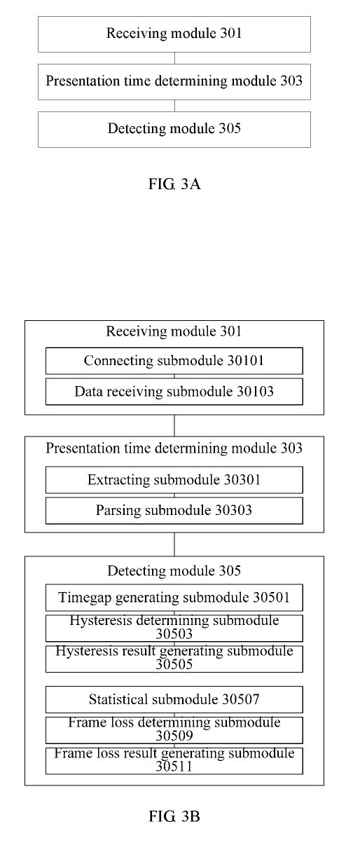

By referring to FIG. 3A, which shows the structural block diagram of one embodiment of the device for detecting video data of the present disclosure, the device may specifically include the following modules:

a receiving module 301 used for receiving frame data of image frames of a video played previously, the frame data including watermark time sequence information;

a presentation time determining module 303 used for extracting the watermark time sequence information from each piece of frame data to determine presentation time of the image frame corresponding to each piece of frame data;

a detecting module 305 used for detecting continuity of the image frames based on the presentation time of the image frames and generating a detection result of the video.

On the basis of FIG. 3A, optionally, the receiving module 301 may include a connecting submodule 30101 and a data receiving submodule 30103, referring to FIG. 3B.

The connecting submodule 30101 therein is used for establishing a connection with a smart terminal where a player resides in a wireless or wired way. The data receiving submodule 30103 is used for receiving the frame data extracted by the smart terminal from specified regions of the image frames, wherein the image frames are image frames played in the video played previously by the player.

In a preferred embodiment of the present disclosure, the presentation time determining module 303 may include the following submodules:

an extracting submodule 30301 used for, with respect to each piece of frame data, extracting the watermark time sequence information from the frame data;

a parsing submodule 30303 used for parsing the extracted watermark time sequence information to determine the presentation time of the image frame corresponding to the frame data.

In a preferred embodiment of the present disclosure, the detecting module 305 may include the following submodules:

a timegap generating submodule 30501 used for calculating a difference value between the presentation time of each image frame and synchronization time information generated in advance to generate a timegap corresponding to each image frame;

a hysteresis determining submodule 30503 used for determining whether the timegaps corresponding to the image frames are within a playing time range, respectively;

a hysteresis result generating submodule 30505 used for regarding the presentation time point of one image frame as a hysteresis time point when the timegap corresponding to the image frame is not within the playing time range, and generating a hysteresis detection result of the video.

Optionally, the detecting module 305 may also include the following submodules:

a statistical submodule 30507 used for performing a statistical operation on the presentation time of the image frames to determine an interframe timegap corresponding to the video and a presentation timegap corresponding to every two adjacent image frames;

a frame loss determining submodule 30509 used for determining whether the presentation timegap corresponding to the two image frames is greater than the interframe timegap;

a frame loss result generating submodule 30511 used for determining loss of data between the two image frames when the presentation timegap is greater than the interframe timegap, and generating a frame loss detection result of the video.

According to this embodiment of the present disclosure, after the frame data of the image frames of the video played previously is received, the watermark time sequence information included in the frame data is extracted to determine the presentation time of the image frame corresponding to each piece of frame data, and the continuity of the image frames is detected on the basis of the presentation time of the image frames and then the detection result of the video is generated; therefore, accurate statistics can be realized on the probability of occurrence of hysteresis and time points of hysteresis, and the accuracy of detection is improved. Meanwhile, the problem of slow detection process due to manual detection on the playing hysteresis of the video is avoided, and the detection efficiency is improved while the workload of the testing technician is reduced.

In regard to the device embodiments, they are just simply described as being substantially similar to the method embodiments, and the correlations therebetween just refer to part of descriptions of the method embodiments.

Each embodiment in this description is described in a progressive manner. Descriptions emphasize on the differences of each embodiment from other embodiments, and same or similar parts of the embodiments just refer to each other.

A person skilled in the art should understand that the embodiments of the present disclosure may be provided as methods, devices, or computer program products. Hence, the embodiments of the present disclosure may be in the form of complete hardware embodiments, complete software embodiments, or a combination of embodiments in both software and hardware aspects. Moreover, the embodiments of the present disclosure may be in the form of computer program products executed on one or more computer-readable storage mediums (including but not limited to a magnetic disk memory, a CD-ROM, an optical memory, etc.) containing therein computer-executable program codes.

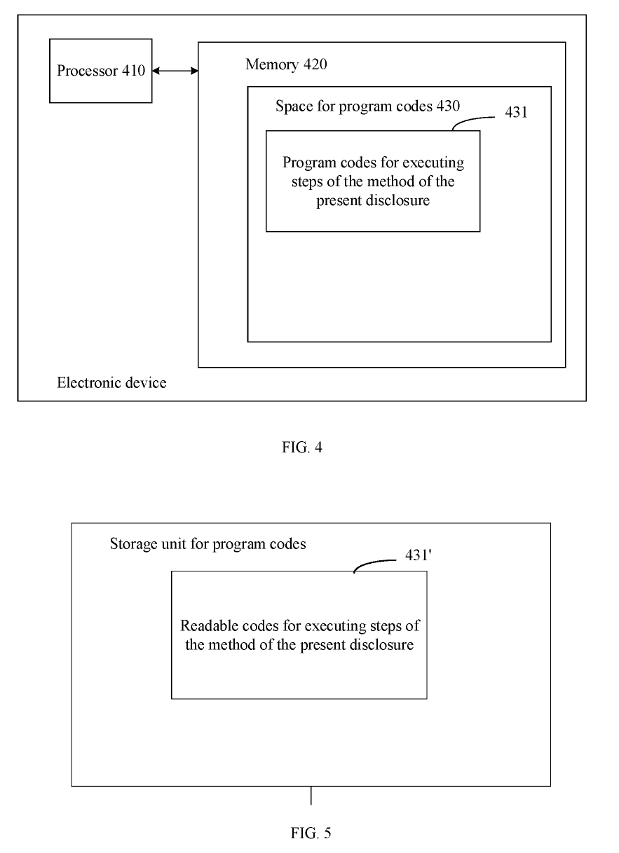

For example, FIG. 4 illustrates a block diagram of an electronic device for executing the method according the disclosure, the electronic device may be the server above. Traditionally, the electronic device includes a processor 410 and a computer program product or a computer readable medium in form of a memory 420. The memory 420 could be electronic memories such as flash memory, EEPROM (Electrically Erasable Programmable Read—Only Memory), EPROM, hard disk or ROM. The memory 420 has a memory space 430 for executing program codes 431 of any steps in the above methods. For example, the memory space 430 for program codes may include respective program codes 431 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 5. The memory cells may be provided with memory sections, memory spaces, etc., similar to the memory 420 of the electronic device as shown in FIG. 4. The program codes may be compressed for example in an appropriate form. Usually, the memory cell includes computer readable codes 431′ which can be read for example by processors 410. When these codes are operated on the electronic device, the electronic device may execute respective steps in the method as described above.

The embodiments of the present disclosure are described with reference to the flow diagrams and/or the block diagrams of the method, the terminal device (system), and the computer program product(s) according to the embodiments of the present disclosure. It should be appreciated that computer program commands may be adopted to implement each flow and/or block in each flow diagram and/or each block diagram, and a combination of the flows and/or the blocks in each flow diagram and/or each block diagram. These computer program commands may be provided to a general-purpose computer, a special-purpose computer, an embedded processor or a processor of other programmable data processing terminal equipment to generate a machine, such that the commands executed by the computer or the processor of other programmable data processing terminal equipment create a device for implementing functions specified in one flow or multiple flows of each flow diagram and/or one block or multiple blocks of each block diagram.

These computer program commands may also be stored in a computer-readable memory that is capable of guiding a computer or other programmable data processing terminal equipment to work in a specific mode, such that the commands stored in the computer-readable memory create a manufacture including a command device for implementing functions specified in one flow or multiple flows of each flow diagram and/or one block or multiple blocks of each block diagram.

Further, these computer program commands may be loaded on a computer or other programmable data processing terminal equipment, such that a series of operation steps are executed on the computer or the other programmable data processing terminal equipment to generate processing implemented by the computer; in this way, the commands executed on the computer or the other programmable data processing terminal equipment provide steps for implementing functions specified in one flow or multiple flows of each flow diagram and/or one block or multiple blocks of each block diagram.

Although the preferred embodiments amongst the embodiments of the present disclosure are already described, another alterations and modifications may be made to these embodiments by those skilled in the art once they learn about the basic creative concept. Hence, the appended claims are meant to be interpreted as including the preferred embodiments and all the alterations and modifications falling into the scope of the embodiments of the present disclosure.

Finally, it still needs to be noted that relational terms such as first, second, and the like in this text are merely used for differentiating one entity or operation from another entity or operation rather than definitely requiring or implying any actual relationship or order between these entities or operations. In addition, the terms “including” and “comprising”, or any other variants thereof are intended to contain non-exclusive including, such that a process, a method, an article or a terminal device including a series of elements includes not only those elements, but also other elements not explicitly listed, or further includes inherent elements of the process, the method, the article or the terminal device. Without more limitations, elements defined by the sentence of “including a . . . ” shall not be exclusive of additional same elements also existing in the process, the method, the article or the terminal device.

The method for detecting video data and the device for detecting video data provided by the present disclosure are introduced above in detail. Specific examples are applied in this text to elaborate the principle and the embodiments of the present disclosure. The descriptions of the above embodiments are merely intended to help understanding the method of the present disclosure and the core concept thereof. Meanwhile, for a person skilled in the art, alterations may be made to the specific embodiments and the application scope according to the concept of the present disclosure. In conclusion, the contents of this description should not be understood as limitations to the present disclosure.

The electronic device in embodiment of the present disclosure may have various types, which include but are not limited to:

(1) a mobile terminal device having the characteristics of having mobile communication functions and mainly aiming at providing voice and data communication. This type of terminals include mobile terminals (such as iPhone), multi-functional mobile phones, functional mobile phones and lower-end mobile phones, etc.;

(2) an ultra portable personal computing device belonging to personal computer scope, which has computing and processing ability and has mobile internet characteristic. This type of terminals include personal digital assistant (PDA) devices, mobile internet device (MID) devices and ultra mobile personal computer (UMPC) devices, such as iPad;

(3) a portable entertainment device which may display and play multi-media contents. This type of device includes audio players, video players (such as an iPod), handheld game players, e-books, intelligent toy, and portable vehicle-mounted navigation devices;

(4) a server providing computing service, the server includes a processor, a hard disk, a memory and a system bus. The server has the same architecture as a computer, whereas, it is required higher in processing ability, stableness, reliable ability, safety, expandable ability, manageable ability etc. since the server is required to provide high reliable service;

(5) other electronic device having data interaction functions.

The device embodiment(s) described above is (are) only schematic, the units illustrated as separated parts may be or may not be separated physically, and the parts shown in unit may be or may not be a physical unit. That is, the parts may be located at one place or distributed in multiple network units. A skilled person in the art may select part or all modules therein to realize the objective of achieving the technical solution of the embodiment.

Through the description of the above embodiments, a person skilled in the art can clearly know that the embodiments can be implemented by software and necessary universal hardware platforms, or by hardware. Based on this understanding, the above solutions or contributions thereof to the prior art can be reflected in form of software products, and the computer software products can be stored in computer readable media, for example, ROM/RAM, magnetic discs, optical discs, etc., including various commands, which are used for driving a computer device (which may be a personal computer, a server or a network device) to execute methods described in all embodiments or in some parts of the embodiments.

Finally, it should be noted that the above embodiments are merely used to describe instead of limiting the technical solution of the present disclosure; although the above embodiments describe the present disclosure in detail, a person skilled in the art shall understand that they can modify the technical solutions in the above embodiments or make equivalent replacement of some technical characteristics of the present disclosure; those modifications or replacement and the corresponding technical solutions do not depart from the spirit and scope of the technical solutions of the above embodiments of the present disclosure.

What is claimed is:

1. A method for detecting video data, comprising:
at an electronic device:
receiving frame data of image frames of a video played previously, the frame data including watermark time sequence information;
extracting the watermark time sequence information from each piece of frame data, and determining presentation time of the image frame corresponding to each piece of frame data;
detecting continuity of the image frames based on the presentation time of the image frames and generating a detection result of the video.

2. The method according to claim 1, wherein receiving the frame data of the image frames of the video played previously comprises:
establishing a connection with a smart terminal where a player resides in a wireless or wired way;
receiving the frame data extracted by the smart terminal from specified regions of the image frames, wherein the image frames are image frames played in the video played previously by the player.

3. The method according to claim 1, wherein extracting the watermark time sequence information from each piece of frame data and determining the presentation time of the image frame corresponding to each piece of frame data comprises:
with respect to each piece of frame data, extracting the watermark time sequence information from the frame data;
parsing the extracted watermark time sequence information and determining the presentation time of the image frame corresponding to the frame data.

4. The method according to claim 1, wherein detecting the continuity of the image frames based on the presentation time of the image frames and generating the detection result of the video comprises:
calculating a difference value between the presentation time of each image frame and synchronization time information generated in advance and generating a timegap corresponding to each image frame;
determining whether the timegaps corresponding to the image frames are within a playing time range, respectively;
when the timegap corresponding to one image frame is not within the playing time range, regarding the presentation time point of the image frame as a hysteresis time point, and generating a hysteresis detection result of the video.

5. The method according to claim 4, wherein detecting the continuity of the image frames based on the presentation time of the image frames and generating the detection result of the video further comprises:
performing a statistical operation on the presentation time of the image frames to determine an interframe timegap corresponding to the video and a presentation timegap corresponding to every two adjacent image frames;
determining whether the presentation timegap corresponding to the two image frames is greater than the interframe timegap;
when the presentation timegap is greater than the interframe timegap, determining loss of data between the two image frames and generating a frame loss detection result of the video.

6. An electronic device for detecting video data, comprising:
at least one processor; and
a memory communicably connected with the at least one processor for storing instructions executable by the at least one processor, wherein execution of the instructions by the at least one processor causes the at least one processor to:
receive frame data of image frames of a video played previously, the frame data including watermark time sequence information;
extract the watermark time sequence information from each piece of frame data and determine presentation time of the image frame corresponding to each piece of frame data;
detect continuity of the image frames based on the presentation time of the image frames and generate a detection result of the video.

7. The electronic device according to claim 6, wherein receive frame data of image frames of a video played previously, the frame data including watermark time sequence information comprises:
establish a connection with a smart terminal where a player resides in a wireless or wired way;
receive the frame data extracted by the smart terminal from specified regions of the image frames, wherein the image frames are image frames played in the video played previously by the player.

8. The electronic device according to claim 6, wherein extract the watermark time sequence information from each piece of frame data and determine presentation time of the image frame corresponding to each piece of frame data comprises:
with respect to each piece of frame data, extract the watermark time sequence information from the frame data;
parse the extracted watermark time sequence information and determine the presentation time of the image frame corresponding to the frame data.

9. The electronic device according to claim 6, wherein detect continuity of the image frames based on the presentation time of the image frames and generate a detection result of the video comprises:
calculate a difference value between the presentation time of each image frame and synchronization time information generated in advance and generate a timegap corresponding to each image frame;
respectively determine whether the timegaps corresponding to the image frames are within a playing time range;
a regard the presentation time point of one image frame as a hysteresis time point when the timegap corresponding to the image frame is not within the playing time range, and generate a hysteresis detection result of the video.

10. The electronic device according to claim 9, wherein detect continuity of the image frames based on the presentation time of the image frames and generate a detection result of the video further comprises:
perform a statistical operation on the presentation time of the image frames and determine an interframe timegap corresponding to the video and a presentation timegap corresponding to every two adjacent image frames;
determine whether the presentation timegap corresponding to the two image frames is greater than the interframe timegap;
determine loss of data between the two image frames when the presentation timegap is greater than the interframe timegap, and generate a frame loss detection result of the video.

11. A non-transitory computer-readable medium storing executable instructions that, when executed by an electronic device, cause the electronic device to:
receive frame data of image frames of a video played previously, the frame data including watermark time sequence information;
extract the watermark time sequence information from each piece of frame data and determine presentation time of the image frame corresponding to each piece of frame data;
detect continuity of the image frames based on the presentation time of the image frames and generate a detection result of the video.

12. The non-transitory computer-readable medium according to claim 11, wherein receive the frame data of the image frames of the video played previously comprises:
establishing a connection with a smart terminal where a player resides in a wireless or wired way;
receiving the frame data extracted by the smart terminal from specified regions of the image frames, wherein the image frames are image frames played in the video played previously by the player.

13. The non-transitory computer-readable medium according to claim 11, wherein extract the watermark time sequence information from each piece of frame data and determining the presentation time of the image frame corresponding to each piece of frame data comprises:
with respect to each piece of frame data, extracting the watermark time sequence information from the frame data;
parsing the extracted watermark time sequence information and determining the presentation time of the image frame corresponding to the frame data.

14. The non-transitory computer-readable medium according to claim 11, wherein detect the continuity of the image frames based on the presentation time of the image frames and generating the detection result of the video comprises:
calculating a difference value between the presentation time of each image frame and synchronization time information generated in advance and generating a timegap corresponding to each image frame;
determining whether the timegaps corresponding to the image frames are within a playing time range, respectively;
when the timegap corresponding to one image frame is not within the playing time range, regarding the presentation time point of the image frame as a hysteresis time point, and generating a hysteresis detection result of the video.

15. The non-transitory computer-readable medium according to claim 14, wherein detect the continuity of the image frames based on the presentation time of the image frames and generating the detection result of the video further comprises:
performing a statistical operation on the presentation time of the image frames to determine an interframe timegap corresponding to the video and a presentation timegap corresponding to every two adjacent image frames;
determining whether the presentation timegap corresponding to the two image frames is greater than the interframe timegap;
when the presentation timegap is greater than the interframe timegap, determining loss of data between the two image frames and generating a frame loss detection result of the video.
